(19) United States
(12) Patent Application Publication
(10) Pub. No.: US 2011/0248141 A1
(43) Pub. Date: Oct. 13, 2011

(54) STEEL COIL POSITIONING STRUCTURE

(76) Inventor: JEN-AN LEE, KAOHSIUNG (TW)

(21) Appl. No.: 12/815,577

(22) Filed: Jun. 15, 2010

(30) Foreign Application Priority Data
Apr. 9, 2010 (TW) 099206338

(51) Int. Cl. F16M 13/00

(52) U.S. Cl. 248/346.5

(57) ABSTRACT

This invention relates to a steel coil positioning structure which at least comprises a positioning seat made of plastic material. The positioning seat comprises at least one base body and two side seat bodies. The base body has a first surface and a second surface opposite to each other. The side seat bodies each having a ramp thereon are fixed on the first surface. The ramps of the side seat bodies are disposed oppositely and directed to center so as to form a bearing surface for placing steel coil thereon. The second surface of the base body is a flat surface. In this manner, steel coils can be positioned stably on the positioning seat. As plastic material is used, manufacturing becomes convenient and quick, and it consumes fewer time and cost in loading into container without conducting pesticide application and fumigation.

### BACKGROUND OF THE INVENTION

1. Field of Invention

This invention relates to a steel coil positioning structure, more particularly to a steel coil positioning structure which can be manufactured very conveniently and quickly, and which consumes fewer time and cost in loading into container.

2. Brief Description of the Prior Art

A steel coil is formed by winding sheet or strip steel onto a reel so that steel coil thus formed itself is formed like a cylinder. Just because steel coil is cylindrical in shape, it should be fixed securely in place so as not to influence driving security during transportation or to endanger operator's life during loading into container. In conventional method of positioning steel coil, a lot of lumber cut into specific shapes and dimensions are used to provide support on the circumference of steel coil. However, this method results in several disadvantages:

1. As the shapes and the dimensions of lumbers for supporting steel coil should be changed according to different dimensions of steel coil, manufacturer of steel coil should prepare lumbers of various dimension specifications in advance. This would increase labor hours and hence cause cost rise.

2. As the lumber is easy to hide insects, hence dosing of pesticide or fumigation for insects should be conducted before loading into container so as not to allow any surviving of insects. However, this operation means to increase cost of loading into container.

### SUMMARY OF THE INVENTION

Therefore, the primary object of the inventor to propose this invention lies in that loading of steel coils into container becomes more convenient, labor saving, without insect pests problem, and the cost can be reduced.

In order to achieve above objects, this invention provides a steel coil positioning structure which at least comprises a positioning seat made of plastic material, the positioning seat having at least one base body and two side seat bodies, the base body having a first surface and a second surface opposite to each other, two side seat bodies each having a ramp thereon being fixed on the first surface, ramps of the two side seat bodies being disposed oppositely and directed to center so as to form a bearing surface for placing steel coils thereon, the second surface of the base body being a flat surface. In this manner, steel coils can be positioned stably on the positioning seat. As plastic material is used, manufacturing becomes convenient and quick, and it consumes fewer time and cost in loading into container without conducting procedures of pesticide application and fumigation.

Furthermore, the second surface of the base body of the positioning seat is formed as a rough surface so that the friction resistance between the positioning seat and the loading surface for pre-disposing the positioning seat is enhanced.

Further, the second surface of the base body of the positioning seat is provided with a lot of elevating parts so that a distance equal to the height of the elevating parts is maintained between the second surface and the loading surface for pre-disposing the positioning seat so as to facilitate the insertion of front forks of fork lift into the space for lifting the positioning seat.

### BRIEF DESCRIPTION OF THE DRAWINGS

FIG. 1 is a perspective view showing the positioning seat of the present invention.

FIG. 2 is a perspective view showing the positioning seat of the present invention after bearing steel coil.

FIG. 3 is a front view showing the positioning seat of the present invention after bearing steel coil.

FIG. 4 is a view showing another embodiment of the positioning seat of the present invention.

FIG. 5 is a view showing still another embodiment of the positioning seat of the present invention.

FIG. 6 is a view showing the first embodiment of the positioning seat of the present invention for bearing steel coil.

FIG. 7 is a view showing the second embodiment of the positioning seat of the present invention for bearing steel coil.

### DETAILED DESCRIPTION OF PREFERRED EMBODIMENTS

The objects, the technical contents and the expected effect of the present invention will become more apparent from the detailed description of the preferred embodiment in conjunction with the accompanying drawings.

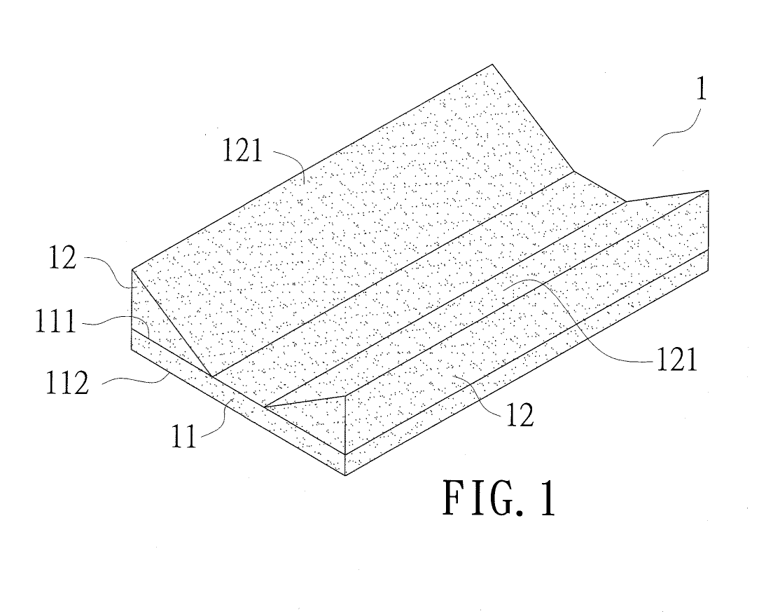

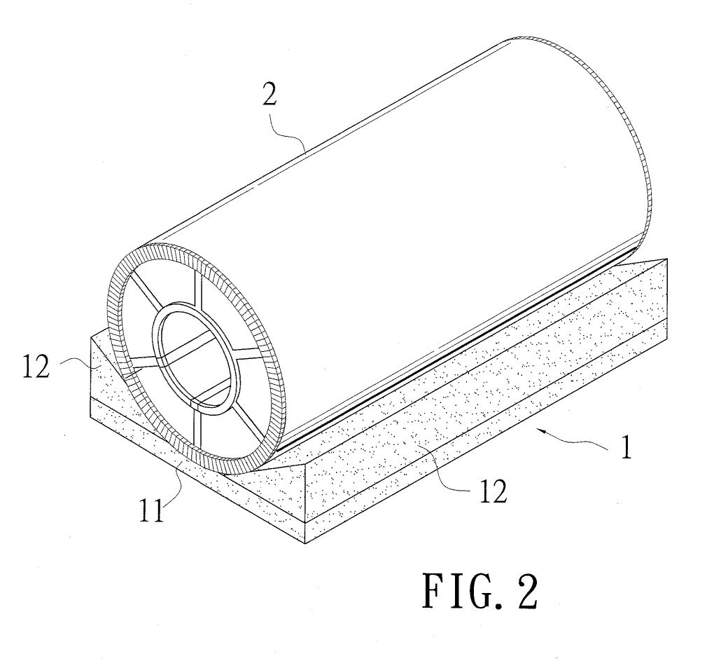

Referring to FIGS. 1 and 2, the steel coil positioning structure of this invention comprises at least one positioning seat (1) made of plastic material. The positioning seat (1) has at least one base body (11) and two side seat bodies (12). The base body (11) has a first surface (111) and a second surface (112) arranged to be opposite to each other. The side seat bodies (12) each having a ramp (121) thereon are fixed on the first surface (111) of the base body (11). The ramps (121) of the side seat bodies (12) are disposed oppositely and directed to the center to form a bearing surface therebetween for placing a steel coil (2) thereon. The second surface (112) of the base body (11) is a flat surface.

The material of the base body (11) and the side seat bodies (12) of the positioning seat (1) can be anyone selected from EVA (ethylene vinyl alcohol copolymer), rubber shap or styrofoam. The hardness of the side seat bodies (12) is made to be higher than that of the base body (11), i.e., the hardness of the side seat bodies (12) is 70˜90, preferably 80, while the hardness of the base body (11) is 60˜80, preferably 70.

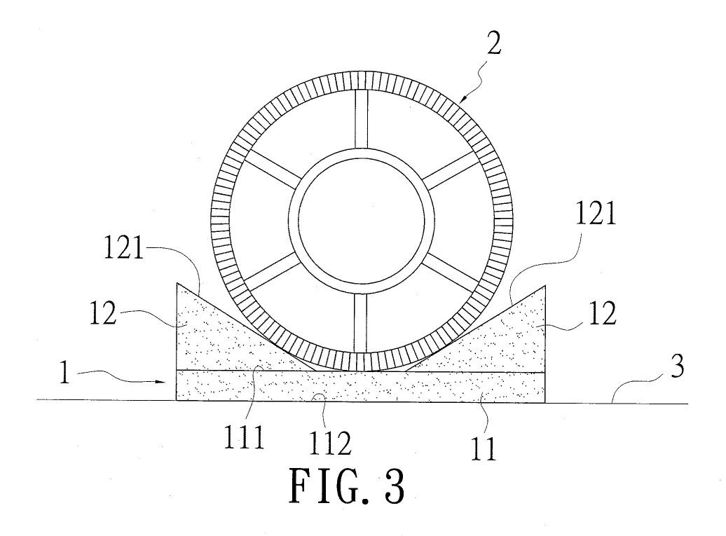

FIGS. 2 and 3 are schematic views showing that the steel coil (2) is placed on the bearing surface formed between the ramps (121) of the two side seat bodies (12). As shown in the figures, since the steel coil (2) has relative large weight, it will press the base body (12) down so as to allow the second surface (112) abut tightly against the loading surface for pre-disposing the positioning seat (1) so as to display positioning effect, when it is place on the bearing surface formed between the ramps (121) of the two side seat bodies (12). Moreover, as the positioning seat (1) is formed by combining the base body (11) and side seat bodies (12) made of plastic material, it is convenient and quick to manufacturing the positioning structure, and it consumes fewer time and cost in loading into container without conducting additional procedures of pesticide application and fumigation.

According to the present invention, the second surface (112) of the base body (11) of the positioning seat (1) is further formed as a rough surface so that the friction resistance between the positioning seat (1) and the loading surface for pre-disposing the positioning seat (1) is enhanced, and further stability of the positioning seat (1) placed on the loading surface can be achieved.

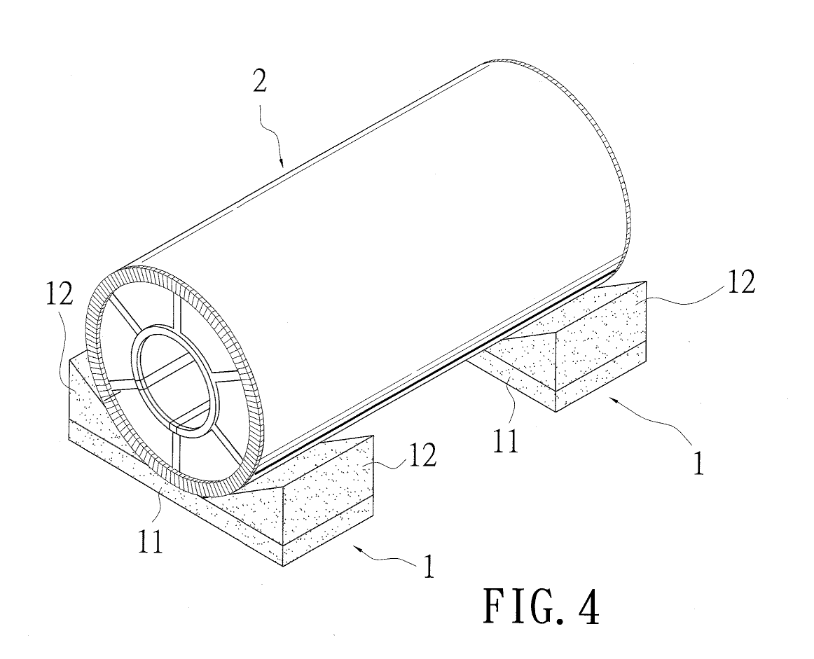

As the positioning seat (1) itself is molded by plastic material, some standard modules can be designed and manufactured according to specific dimensions requirement so as to cope with various demands. Alternatively, the positioning seat (1) can be cut into shorter size after molding, as shown in FIG. 4, two positioning seats (1) after suitably cutting are supported beneath two ends of a steel coil (2).

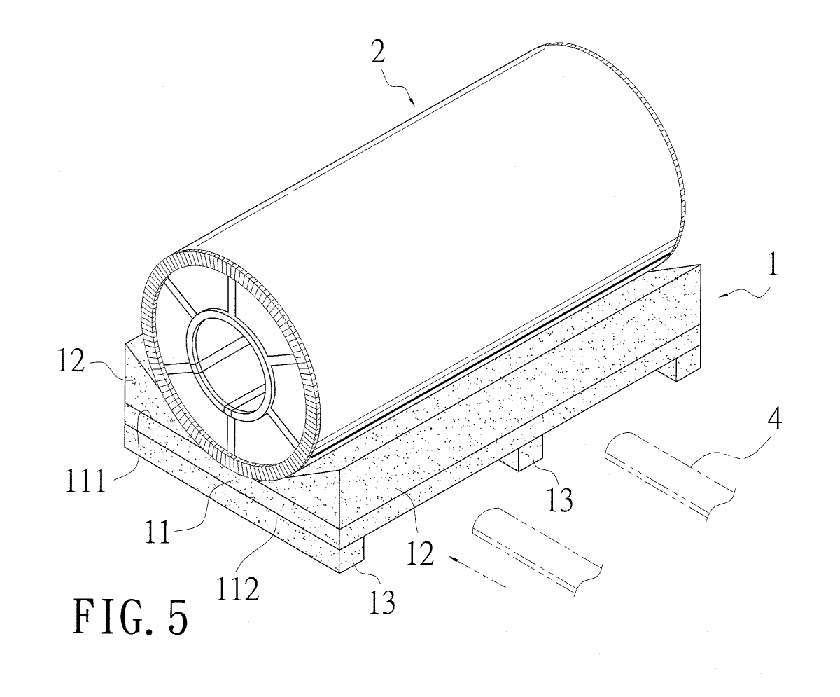

Further according to the present invention, a lot of elevating parts (13) are provided on the second surface (112) of the base body (11) of the positioning seat (1), referring to FIG. 5, then a distance equal to the height of the elevating parts (13) is maintained between the second surface (112) of the base body (11) of the positioning seat (1) and the loading surface for pre-disposing the positioning seat (1), i.e., a space is formed so as to facilitate the insertion of front forks (4) of fork lift for lifting the positioning seat (1).

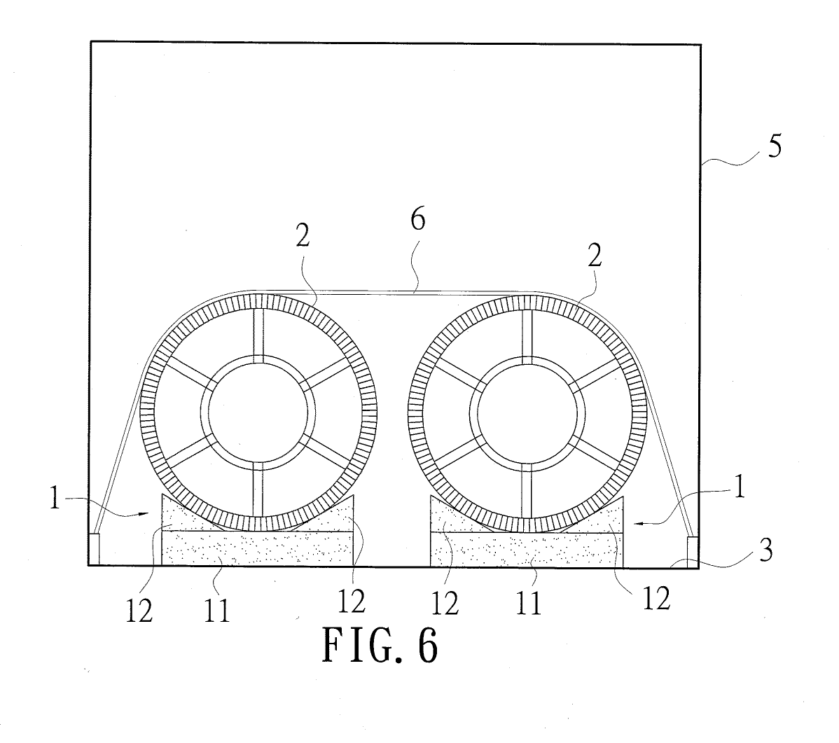

Again referring to FIG. 6 schematically showing the steel coils (2) set in the container (5), two steel coils (2) are loaded in the container (5) and each steel coil (2) is positioned on its own positioning seat (1). Then, tie-up elements (6) are used to tighten the steel coils (2) in place. The tie-up elements (6) can be steel stripe or steel rope.

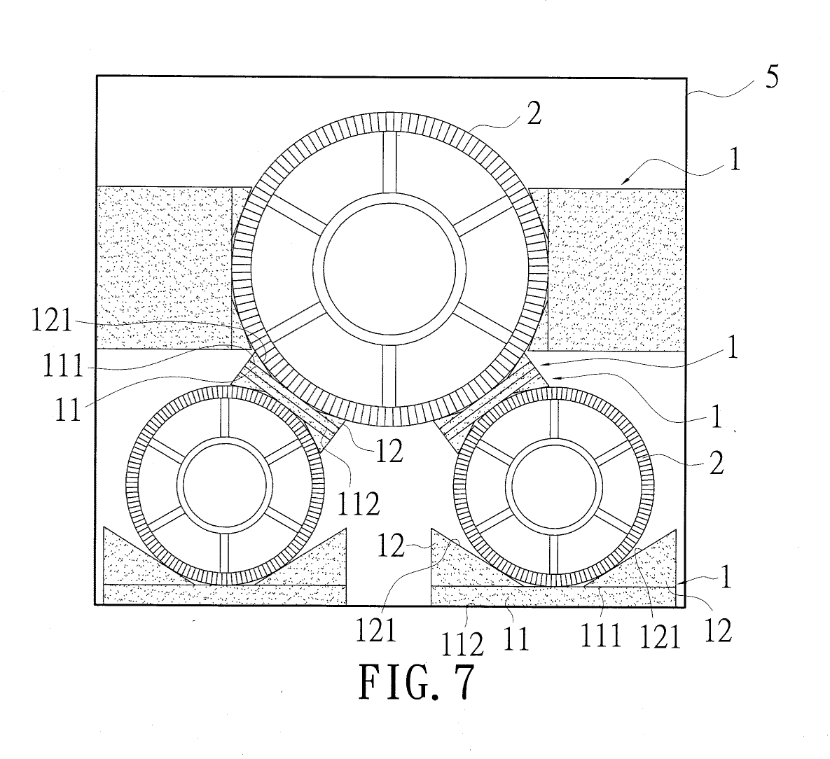

FIG. 7 is a schematic view showing another embodiment of setting steel coils (2) in the container (5). As shown in the figure, three steel coils (2) in overlapped state are loaded into the container (5), in which two steel coils (2) are positioned respectively on their own positioning seats (1) placed on the loading surface (3) of the container (5), then the third steel coil (2) is disposed between and over the two steel coils (2). Two positioning seats (1) with their second surfaces (112) of the base body (11) abutted against each other are interposed between the third steel coil (2) and each of the other two steel coils (2) respectively, and the bearing surface formed between the ramps (121) of two side seat bodies (12) of each positioning seat (1) is directed to the corresponding steel coil (2). Additionally, positioning seats (1) are also provided between two sides of the third steel coil (2) and two side walls of the container (5), similarly the bearing surface formed between the ramps (121) of two side seat bodies (12) of each positioning seat (1) is directed to the third steel coil (2) and the second surfaces (112) of the base body (11) of the positioning seats (1) are respectively abutted against the side walls of the container (5).

While the present invention has been described by the above embodiments in conjunction with accompanying drawings, it is noted that the above embodiments are not intended to restrict the present invention. Various modifications and variations conducted without departing from the spirit and scope of the present invention are still considered to be within the scope of the present invention, which is defined in the appended claims.

What is claimed is:

1. A steel coil positioning structure, comprising at least one positioning seat made of plastic material, said positioning seat having at least one base body and two side seat bodies, said base body having a first surface and a second surface opposite to each other, said two side seat bodies each having a ramp directed to center being fixed on said first surface so as to form a bearing surface for placing steel coils thereon, the hardness of said side seat bodies being 70˜90 and the hardness of said base body being 60˜80.

2. The steel coil positioning structure as claimed in claim 1, wherein said second surface is a rough surface.

3. The steel coil positioning structure as claimed in claim 2, wherein said second surface of said base body is provided with a lot of elevating parts.

4. The steel coil positioning structure as claimed in claim 2, wherein said steel coil positioning structure further comprises tie-up elements, which can be steel stripe or steel rope.

5. The steel coil positioning structure as claimed in claim 1, wherein said second surface of said base body is provided with a lot of elevating parts.

6. The steel coil positioning structure as claimed in claim 1, wherein said steel coil positioning structure further comprises tie-up elements, which can be steel stripe or steel rope.
